(19) United States
(12) Patent Application Publication
(10) Pub. No.: US 2024/0029959 A1
(43) Pub. Date: Jan. 25, 2024

(54) INTERMEDIATE CIRCUIT CAPACITOR FOR A MOTOR VEHICLE, CAPACITOR DEVICE, MOTOR VEHICLE AND METHOD FOR PRODUCING AN INTERMEDIATE CIRCUIT CAPACITOR

(71) Applicant: ZF Friedrichshafen AG, Friedrichshafen (DE)

(72) Inventors: Fabian Döllinger, Kressbronn am Bodensee (DE); Michael Kohr, Bodnegg (DE); Ivonne Trenz, Friedrichshafen (DE); Pengshuai Wang, Eriskirch (DE); Jonas Zeller, Friedrichshafen (DE)

(73) Assignee: ZF Friedrichshafen AG, Friedrichshafen (DE)

(21) Appl. No.: 18/355,117

(22) Filed: Jul. 19, 2023

(30) Foreign Application Priority Data
Jul. 21, 2022 (DE) 102022207437.8

(51) Int. Cl. H01G 4/32; H01G 4/224; H01G 4/236

(52) U.S. Cl. CPC H01G 4/32; H01G 4/224; H01G 4/236

(57) ABSTRACT

A link capacitor for a motor vehicle has a housing, a first busbar and a second busbar for electrical contact to the link capacitor, and at least one coupling element. The housing accommodates a winding for the link capacitor. The first busbar and second busbar are connected to the winding. The coupling element is on the housing and designed to couple the link capacitor to an adjacent link capacitor and/or to a support element.

### CROSS-REFERENCE TO RELATED APPLICATION

This application claims priority to German Application No. DE 10 2022 207 437.8, filed on Jul. 21, 2022, the entirety of which is hereby fully incorporated by reference herein.

### FIELD

The present invention relates to a link capacitor for a motor vehicle, a capacitor assembly, a motor vehicle, and a method for producing the link capacitor.

### BACKGROUND AND SUMMARY

There are link capacitors, such as film capacitors, which have solder pins, a plastic housing, grouting and a film winding.

Based on this, the present invention results in an improved link capacitor for a motor vehicle, an improved capacitor assembly, an improved motor vehicle, and an improved method for producing a link capacitor according to the independent claims. Advantageous embodiments can be derived from the dependent claims and the following description.

The advantages that can be obtained with the proposed approach are that a link capacitor is obtained that that can be reliably, quickly and easily coupled to an adjacent link capacitor and/or a support element.

A link capacitor for a motor vehicle has a housing, a first busbar and a second busbar for obtaining electrical contact with the link capacitor, and at least one coupling element. A winding of the link capacitor is encased in the housing. The first busbar and second busbar are connected to the winding. The coupling element is on the housing and designed to couple the link capacitor to the adjacent link capacitor, and/or to the support element.

The link capacitor can be an electrical capacitor. The link capacitor can be used, merely by way of example, for a power converter, e.g. an HVDC converter, inverter charger, etc. or for power electronics. The link capacitor can thus be placed in a link for an inverter. The inverter can be an electrical device that converts direct current to alternating current. The motor vehicle can be a motor vehicle with an electric drive. The first busbar and second busbar can extend at least partially out of the housing. The first busbar and/or second busbar can also form contacts for a printed circuit board, with which direct contact to the printed circuit board can be obtained. When the coupling element is used to couple the link capacitor to a support element, movement of the link capacitor can be blocked in relation to the coupling element in at least one direction. According to various exemplary embodiments, the link capacitor can contain numerous coupling elements. By way of example, one coupling element can be used to couple the link capacitor to another link capacitor, and another coupling element can be used to couple the link capacitor to the support element. It is also possible to use two coupling elements, for example, to couple the capacitor to the another link capacitor. The coupling elements in a link capacitor can all be identical, or some of them can be different.

The approach presented herein can also be understood to be a mechanical concept for a modular link capacitor. A modular link capacitor is distinguished by its structure comprising individual, discrete components, the capacities and numbers of which can vary. The approach presented herein can result in an assembly concept and an attachment concept. The main feature of the approach presented herein is the possibility of circumventing the time-consuming and expensive grouting process comprising coating the individual capacitor windings with a thermosetting plastic. Moreover, it may be possible to obtain parts in bulk, thus reducing the production costs. There is also the possibility of implementing the concept without any, or with fewer, additional securing components. The approach presented herein may result in a universal link capacitor, also reducing production costs. The link capacitor can exhibit low leakage inductance and a low number of individual components. It is also possible to obtain a material bonded connection to adjacent busbars, preferably through laser welding.

The link capacitor can have a complementary coupling element. The coupling element can be designed to couple the link capacitor to a first complementary coupling element on a first adjacent link capacitor. The complementary coupling element can be designed to couple the link capacitor to a second coupling element on a second adjacent link capacitor. This advantageously results in a reliable and space-saving coupling of the link capacitors. If each link capacitor in a group of link capacitors has both a coupling element and a complementary coupling element, the link capacitors can be arranged in an arbitrary sequence. The form of the complementary coupling element can be adapted to the form of the coupling element. The link capacitor can contain numerous complementary coupling elements that are identical to the coupling element, or some of the complementary coupling elements may have a different design.

The coupling element and the complementary coupling element can both be placed on the top or the bottom of the housing. This simplifies assembly. Alternatively, one can be on top and the other can be on the bottom.

The coupling element can also be on the side of the housing. The complementary coupling element can then be on the other side. This enables the link capacitors to be coupled to one another simply by sliding them together.

The coupling element can be designed such that the link capacitors can be coupled to one another or the support element in a form-fitting or force-fitting manner. This results in an advantageous space-saving and quick assembly of the link capacitors. Unoccupied coupling elements or complementary coupling elements at the ends of a series can be used as positioning aids during assembly. The coupling element and/or complementary coupling element can be formed by a mounting bracket, a dovetail connection, a screw connection, or a frame. Advantageously, universal fasteners can be used.

The coupling element can be formed by a pin, a projection, or a tab, and/or a recess or a hole. This simplifies assembly.

The coupling element and/or the complementary coupling element can protrude at least in part from the housing. This results in a particularly robust coupling.

The link capacitor can be attached to the adjacent link capacitor and/or the support element by a fastener. The link capacitor can thus be reliably secured in place in this manner.

The housing and coupling element can be formed by coating the winding with a thermosetting plastic. The complementary coupling element can also be formed by coating the winding with a thermosetting plastic. This use of plastic coating, preferably with a thermosetting plastic, advantageously results in a production process with which time-consuming and expensive casting processes can be avoided. The link capacitors can be easily produced in bulk as a result.

A capacitor assembly comprises an embodiment of the link capacitor specified herein and an adjacent link capacitor. The coupling element on the link capacitor is coupled to a first complementary coupling element on the adjacent link capacitor. The capacitor assembly can be advantageously obtained without separate fastening components, thus reducing costs and saving time.

The capacitor assembly can contain a support element. The link capacitor and/or the adjacent link capacitor can be placed on the support element. By way of example, the support element can form part of a housing.

The capacitor assembly can comprise a retaining element that is designed to anchor the link capacitor and/or the adjacent link capacitor to the support element. This retaining element advantageously results in a reliable anchoring of the link capacitor and the adjacent link capacitor.

The link capacitor can be attached to the adjacent link capacitor and/or the support element with an adhesive. This advantageously eliminates the need for additional components, thus reducing costs. In particular, the use of an adhesive eliminates the need for a retaining element.

The capacitor assembly can contain a printed circuit board that can be electrically connected to the link capacitor and/or the adjacent link capacitor. Electrical contact to the link capacitor can be obtained with the printed circuit board. The use of this printed circuit board eliminates the need for a retaining element or an adhesive.

The capacitor assembly can be used in conjunction with a power converter, an HVDC converter, a charger, e.g. for inverter charging, or with power electronics.

The invention also relates to an electric axle drive for a motor vehicle that has at least one electric machine, a transmission, and an embodiment of the power converter described herein, an HVDC converter, a charger, e.g. for inverter charging, or power electronics.

The power converter can be an inverter. The electric machine can be supplied by the power converter with an alternating current necessary for the operation thereof. The transmission can convert a torque from the electric machine to a drive torque for at least one of the wheels on the motor vehicle. The transmission can contain a gearing for reducing the rotational rate of the electric machine and it can also contain a differential.

The invention also relates to a motor vehicle that contains an embodiment of the power converter specified herein, or an HVDC converter, or a charger, e.g. for inverter charging, or power electronics, and/or an embodiment of the electric axle drive specified herein.

A motor vehicle contains an embodiment of the link capacitor specified herein. The advantages of the approach described herein can be efficiently obtained with such an embodiment.

The motor vehicle according to the invention contains an embodiment of the link capacitor specified herein. The advantages of the approach described herein can also be obtained with this embodiment.

A method for producing an embodiment of the link capacitor specified herein comprises a step in which the capacitor is provided and a step in which it is coated. In the provision step, a winding and a first and second busbar are provided. In the coating step, the winding is coated with a thermosetting plastic, in which a housing is formed that has a coupling element for coupling the link capacitor to an adjacent link capacitor and/or to a support element. The advantages of the approach described herein can also be efficiently obtained with this embodiment.

The invention shall be explained below in greater detail in reference to the drawings.

### BRIEF DESCRIPTION OF THE DRAWINGS

FIG. 1 shows an illustration of an exemplary embodiment of a link capacitor;

FIG. 2 shows an illustration of an exemplary embodiment of a link capacitor;

FIG. 3 shows an illustration of an exemplary embodiment of a link capacitor;

FIG. 4 shows an illustration of an exemplary embodiment of a link capacitor;

FIG. 5 shows an illustration of a capacitor assembly according to an exemplary embodiment;

FIG. 6 shows an illustration of a capacitor assembly according to an exemplary embodiment;

FIG. 7 shows an illustration of an exemplary embodiment of a link capacitor;

FIG. 8 shows an illustration of an exemplary embodiment of a link capacitor;

FIG. 9 shows an illustration of an exemplary embodiment of a link capacitor;

FIG. 10 shows an illustration of an exemplary embodiment of a link capacitor;

FIG. 11 shows an illustration of an exemplary embodiment of a link capacitor;

FIG. 12 shows an illustration of a capacitor assembly according to an exemplary embodiment;

FIG. 13 shows an illustration of an exemplary embodiment of a link capacitor;

FIG. 14 shows an illustration of an exemplary embodiment of a link capacitor;

FIG. 15 shows a top view of an exemplary embodiment of a link capacitor;

FIG. 16 shows an illustration of a capacitor assembly according to an exemplary embodiment;

FIG. 17 shows an illustration of an exemplary embodiment of a link capacitor;

FIG. 18 shows an illustration of a capacitor assembly according to an exemplary embodiment;

FIG. 19 shows an illustration of an exemplary embodiment of a link capacitor;

FIG. 20 shows an illustration of a capacitor assembly according to an exemplary embodiment;

FIG. 21 shows an illustration of an exemplary embodiment of a link capacitor;

FIG. 22 shows an illustration of a capacitor assembly according to an exemplary embodiment;

FIG. 23 shows a flow chart of an exemplary embodiment of a method for producing the link capacitor; and

FIG. 24 shows a schematic illustration of an exemplary embodiment of a motor vehicle.

### DETAILED DESCRIPTION

The same or similar reference symbols are used for the elements with similar functions shown in the drawings in the following description of preferred exemplary embodiments of the present invention, wherein the descriptions of these elements shall not be repeated.

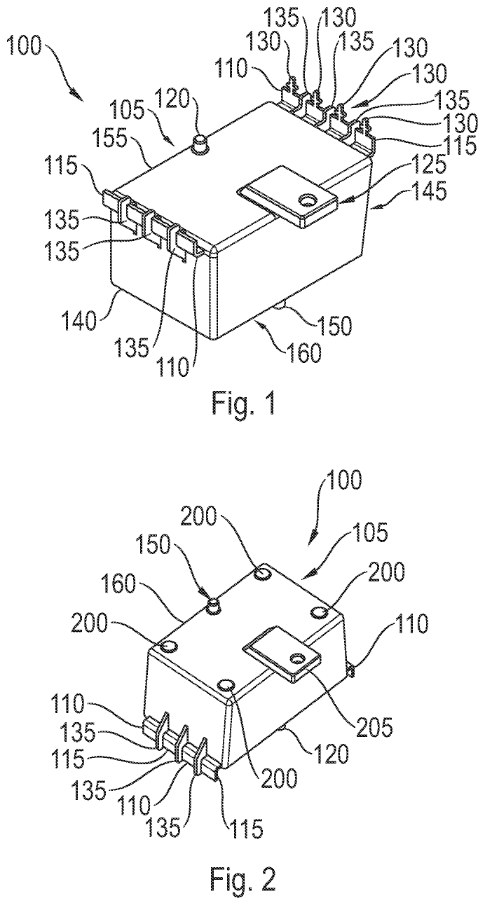

FIG. 1 shows an illustration of an exemplary embodiment of a link capacitor 100 for a motor vehicle. The motor vehicle can be a motor vehicle with an electric drive. The link capacitor can be an electrical capacitor for a power converter, e.g. an HVDC converter, an inverter charger, etc. or for power electronics in the motor vehicle, or it can be used for some other device.

The link capacitor 100 has a housing 105, at least one first busbar 110, at least one second busbar 115, and a coupling element 120. The link capacitor can also have a complementary coupling element 125.

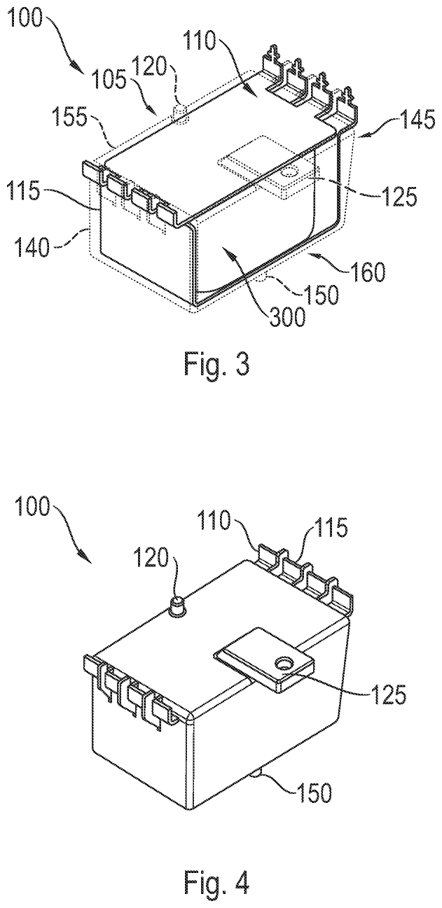

A winding 300 of the link capacitor 100 is encased in the housing 105, see FIG. 3. The housing 105 is rectangular in one exemplary embodiment, although it can also have different shapes. The first busbar 110 and second busbar 115 form the electrical contacts of the link capacitor 100. The first busbar 110 and second busbar 115 are connected to the winding for this. The busbars 110, 115 are flat, thus forming flat strips. In one exemplary embodiment, the first busbar 110 and second busbar 115 extend partially out of the housing 105 to form electrical contacts for the link capacitor 110. More precisely, the ends of the busbars 110, 115 extend out of the housing 105 from under a top 155 of the housing 105, such that the first ends of the busbars 110, 115 extend from one side of the housing 105 and the second ends of the busbars 110, 115 extend from an opposite side of the housing 105. In one exemplary embodiment, these ends of the busbars 110, 115 are bent.

The first busbar 110 and second busbar 115 thus each form two first ends and two second ends, in which the ends of the first busbar 110 and the ends of the second busbar 115 alternate.

According to one exemplary embodiment, the busbars 110, 115 each have a contact 130 for a printed circuit board, which can also be referred to as a printed circuit board contact. The contacts 130 are on the first ends of the busbars 110, 115, for example. The contacts 130 form so-called press-fit pins or solder pins.

According to one exemplary embodiment that has numerous first busbars 110 and second busbars 115, the link capacitor 100 has numerous separating webs 135. One separating web 135 is located between each first busbar and second busbar. These separating webs 135 are designed to maintain clearances and creepage distances. The separating webs 135 are located on a first side wall 140 of the housing 105 and a second, opposite side wall 145 of the housing 105. The separating webs 135 can be attached to the housing 105 or formed as an integral part of the housing 105, or obtained with a separate plastic insert.

According to one exemplary embodiment, the coupling element 120 is formed by a securing pin on the housing 105 or by a part of the housing 105. More precisely, the coupling element 120 is located on an edge of the top 155 of the housing 105. The complementary coupling element 125, which can also be referred to as a mounting bracket, is opposite the coupling element 120 on the other edge of the top 155, such that the coupling element 120 and complementary coupling element 120 are on different, opposing sides of the housing. In one exemplary embodiment, the coupling element 120 is a pin that is perpendicular to the top 155. The complementary coupling element 125 is formed by a hole for the pin. The complimentary coupling element 125 extends beyond the edge of the housing 105. This complimentary coupling element 125 is formed by a tab on the top 155 that extends beyond the edge of the housing 105. In one embodiment, the complimentary coupling element 125 has a hole in the part extending beyond the edge that fits over the pin forming the coupling element on another link capacitor. In one exemplary embodiment, the tab is as thick as the length of the pin.

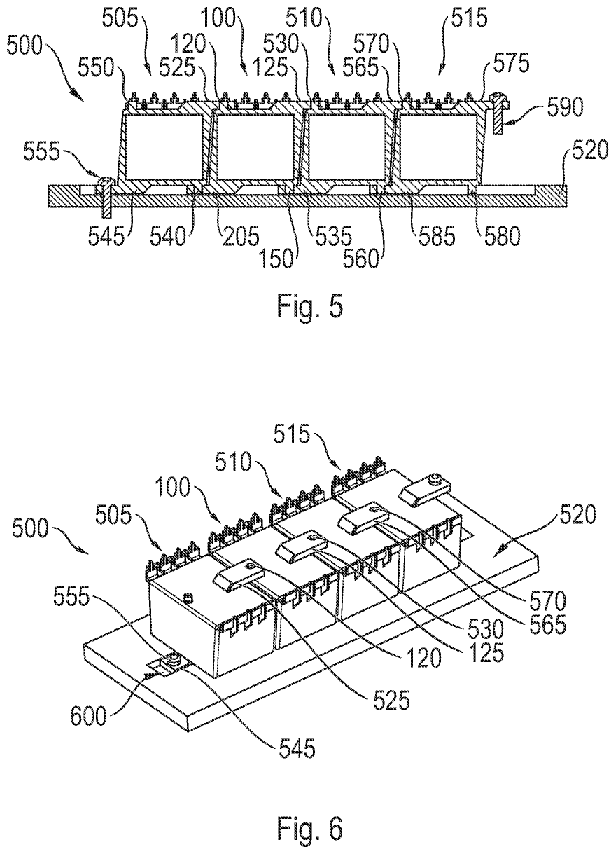

The coupling element 120 is designed to couple the link capacitor 100 to an adjacent link capacitor and/or a support element. The adjacent link capacitor and the support element are described in greater detail in reference to FIG. 5.

The link capacitor 100 in one exemplary embodiment has another coupling element 150 on the bottom 160 of the housing 105. This other coupling element 150 is designed, for example, to couple the link capacitor 100 to an adjacent link capacitor and/or the support element. In one exemplary embodiment, the other coupling element and the complementary coupling element 125 are on the same side of the housing 105. The coupling element 120 and the complementary coupling element 125 can also be the same shape. The link capacitor can also have another complementary coupling element, not visible in FIG. 1, which is located opposite the coupling element 120 on the bottom 160 of the housing 105.

FIG. 2 shows an illustration of an exemplary embodiment of a link capacitor 100 for an inverter in a motor vehicle. This can be the link capacitor described in reference to FIG. 1, differing only in that the link capacitor 100 is rotated 180° in FIG. 2, such that the bottom 160 of the housing 105 is visible.

In one exemplary embodiment, the link capacitor 100 has numerous support points 200. By way of example, there is one support point 200 at each corner of the bottom 160, each in the shape of small, circular bump. The other coupling element 150 is also on the bottom 160. There is also another complementary coupling element 205 on the bottom of the housing 105.

The other coupling element 150 is also in the form of a pin, like the first coupling element 120. The other coupling element 150 is on the bottom 160, and the first coupling element 120 is on the top 155, such that the coupling elements 120, 150 are on opposite sides of the housing 100. More precisely, the coupling elements 120, 150 are diagonally opposite one another.

The other complementary coupling element 205 is the same shape as the first complementary coupling element in FIG. 1, forming a tab with a hole. The other complementary coupling element 205 also extends away from the housing 105. The other complementary coupling element 205 is diagonally opposite the first complementary coupling element, which is not visible in FIG. 2.

FIG. 3 shows an illustration of an exemplary embodiment of a link capacitor 100 for an inverter in a motor vehicle. This can be the link capacitor described in reference to FIG. 1, with the exception that the winding 300 is shown, which can also be referred to as a capacitor winding. The housing 105 is indicated by a dotted line. The first busbar 110 is between the top 155 of the housing 105 and the winding 300, such that the first busbar 110 is flat, extending in the form of a flat strip over the entire length and width of the winding 300. In one exemplary embodiment, the top 155 forms a lid. The second busbar 115 is also between the housing 105 and the winding 300, and is U-shaped, such that the second busbar 115 follows the side wall 140, the bottom 160 and the other side wall 145. The first busbar 110 can also be referred to as the positive DC busbar, and the second busbar 115 can be referred to as the negative DC busbar.

FIG. 4 shows an illustration of an exemplary embodiment of a link capacitor 100 for an inverter in a motor vehicle. This can be the link capacitor described in reference to the preceding figures with the exception that the contact to the busbars 110, 115 omitted. FIG. 4 can also be referred to as a variation without printed circuit board contact.

FIG. 5 shows an illustration of a capacitor assembly 500 according to an exemplary embodiment. The capacitor assembly 500 contains a link capacitor 100 and a first adjacent link capacitor 505. The link capacitor 100 can be the link capacitor described in reference to the preceding figures. According to one exemplary embodiment, the capacitor assembly 500 has a second adjacent link capacitor 510 and a third adjacent link capacitor 515. These link capacitors 500, 505, 510, 515 can advantageously all have the same shape, and be arranged in a row directly adjacent one another. By way of example, the link capacitor 100 is between the first adjacent link capacitor 505 and the second adjacent link capacitor. The second adjacent link capacitor 510 is between the link capacitor 100 and the third adjacent link capacitor 515. The link capacitors 100, 505, 510, 515 are on a support element 520 in this exemplary embodiment.

The coupling element 120 on the link capacitor 100 is designed to couple the link capacitor 100 to the first adjacent link capacitor 505 with a first complementary coupling element 525 thereon. The complementary coupling element 125 on the link capacitor 100 is designed to couple the link capacitor 100 to the second adjacent link capacitor 510 with a second coupling element 530 thereon. The other coupling element 150 on the link capacitor 100 is designed to couple the link capacitor 100 to the second adjacent link capacitor 510 with a second complementary coupling element 535 thereon. In one exemplary embodiment, the second adjacent link capacitor 510 has another second complementary coupling element 565 and another second coupling element 560, in addition to the second complementary coupling element 535 and the second coupling element 530.

The other complementary coupling element 205 on the link capacitor 100 is designed to couple to a first coupling element 540 on the first adjacent link capacitor 505. In one exemplary embodiment, the first adjacent link capacitor 505 also has another first complementary coupling element 545 and another first coupling element 550 in addition to the first complementary coupling element 525 and the first coupling element 540. The other first complementary coupling element 545 is attached to the support element 520 with a fastener 555, by way of example. The position of the fastener 555 can also be referred to as a fastening point.

The third adjacent link capacitor 515 has a third coupling element 570, another third coupling element 580, a third complementary coupling element 575 and another third complementary coupling element 585, wherein the other second complementary coupling element 565 on the second adjacent link capacitor 510 is coupled to the third coupling element 570 on the third adjacent link capacitor 515. The other second coupling element 560 on the second adjacent link capacitor 510 is coupled to the other third complementary coupling element 580 on the third adjacent link capacitor 515. In one exemplary embodiment, another fastener 590 is placed in a hole through the third complementary coupling element 575 to attach the capacitor assembly 500 to a vehicle component, for example.

The link capacitors 100, 505, 510, 515 have the same shape according to one exemplary embodiment, and therefore also have identical coupling elements 120, 150, 530, 540, 550, 560, 570, 580, in the form of pins, and complementary coupling elements 125, 205, 525, 535, 545, 565, 575, 585 in the form of mounting brackets, such that the link capacitors 100, 505, 510, 515 can be coupled to one another and/or the support element 520 in a form-fitting and/or force-fitting manner using the coupling elements 120, 150, 530, 540, 550, 560, 570, 580 and the complementary coupling elements 125, 205, 525, 535, 545, 565, 575, 585.

According to one exemplary embodiment, the busbars on the link capacitors 100, 505, 510, 515 are on a side of the link capacitors 100, 505, 510, 515 facing away from the support element 520. The support element 520 can also have a groove that the coupling elements 150, 540, 560, 580 and the complementary coupling elements 205, 535, 545, 585 fit into.

FIG. 6 shows an illustration of a capacitor assembly 500 according to an exemplary embodiment. This can be the capacitor assembly described in reference to FIG. 5. The coupling elements 120, 530, 570 in the form of pins are designed to fit in the holes through the complementary coupling elements 525, 125, 565 in a form fitting manner. According to one exemplary embodiment, the support element 520 has a groove 600 in which the fastener 555 for the other first complementary coupling element 545 is secured. The support element 520 can also be referred to as a housing dummy.

According to one exemplary embodiment, relative movement of link capacitors 500, 505, 510, 515 in the longitudinal direction of the row of link capacitors 500, 505, 510, 515 is prevented by the coupled pairs of coupling elements 120, 530, 570 and complementary coupling elements 525, 125, 565. The groove 600 also prevents a lateral movement of the link capacitors 500, 505, 510, 515 transverse to the longitudinal direction of the row of link capacitors 500, 505, 510, 515. It is therefore sufficient if only the outer, or only one of the outer link capacitors in the row of link capacitors 500, 505, 510, 515 is secured to the support element 520.

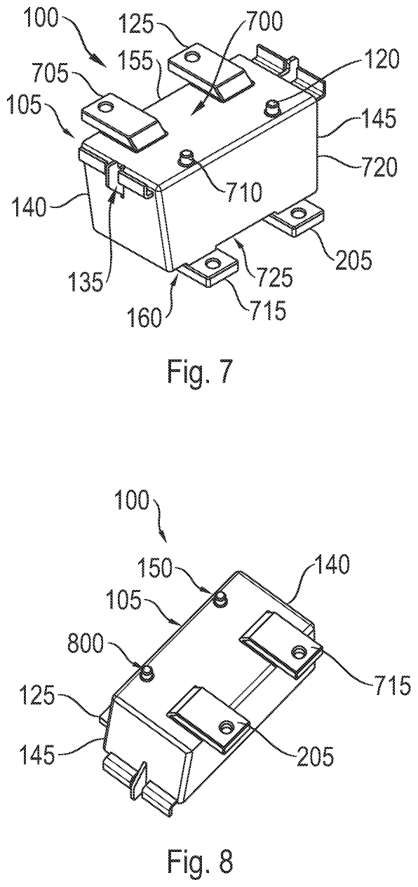

FIG. 7 shows an illustration of an exemplary embodiment of a link capacitor 100 for an inverter in a motor vehicle. This link capacitor is similar to the link capacitor shown in FIG. 1, with the exception that the link capacitor 100 has supplementary coupling elements and supplementary complementary coupling elements. The housing 105 can also be narrower than the housing in FIG. 1, and there are fewer busbars 110, 115 than on the link capacitor shown in FIG. 1. The housing 105 also has a separating web 135 on the first side wall 140 and on the second side wall 145 lying opposite the first side wall 140.

According to one exemplary embodiment, there is a supplementary complementary coupling element 705 on the top 155 adjacent to the complementary coupling element 125. There can be an empty space between the complementary coupling element 125 and the supplementary complementary coupling element 705, e.g. for an optional retaining element. By way of example, the complementary coupling element 125 and the supplementary complementary coupling element 705 are identical and parallel to one another.

According to one exemplary embodiment, there is another supplementary complementary coupling element 715 adjacent to the other complementary coupling element 205 on the bottom 160. A recess 725 can be formed on the bottom 160 between the other complementary coupling element 205 and the other supplementary complementary coupling element 715.

According to one exemplary embodiment, there is a supplementary coupling element 710 adjacent to the coupling element 120 on the top 155. The coupling elements 120, 710 are directly opposite the complementary coupling elements 125, 705, for example.

The coupling elements 120, 710 are adjacent to a side wall 720, beyond which the complementary coupling element 205 and the other supplementary complementary coupling element 715 extend.

FIG. 8 shows an illustration of an exemplary embodiment of a link capacitor 100 for an inverter in a motor vehicle. This can be the link capacitor described in reference to FIG. 7, differing only in that the link capacitor 100 is rotated 180° in FIG. 8, such that the bottom 160 of the housing 105 is visible.

According to one exemplary embodiment, there is another supplementary coupling element 800 adjacent to the other coupling element 150 on the bottom 160.

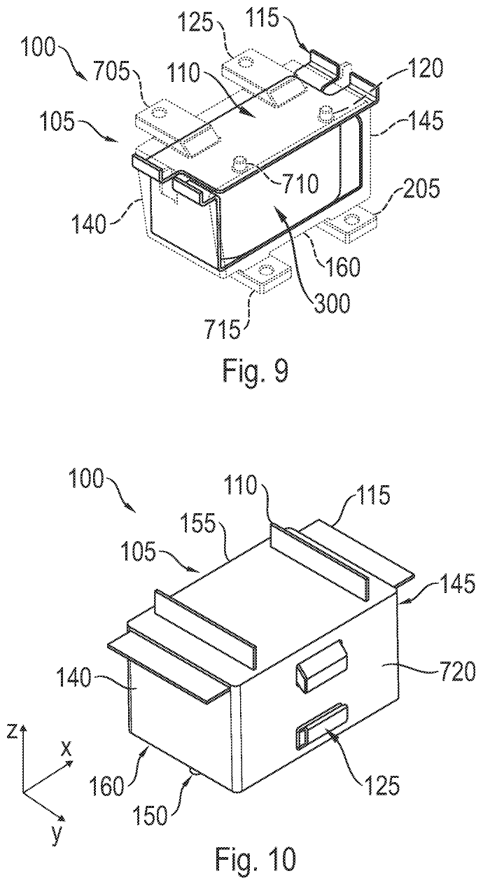

FIG. 9 shows an illustration of an exemplary embodiment of a link capacitor 100 for an inverter in a motor vehicle. This can be the link capacitor described in reference to FIG. 7, wherein the winding 300 is shown herein. The housing 105 is indicated by a dotted line. The first busbar 110 is between the top 155 of the housing 105 and the winding 300, and the first busbar 110 is in the form of a flat strip. The second busbar 115 is also between the top 105 and that winding 300, and is U-shaped, such that the second busbar 115 follows the first side wall 140, the bottom 160, and the second side wall 145 opposite the first side wall 140.

FIG. 10 shows an illustration of an exemplary embodiment of a link capacitor 100 for an inverter in a motor vehicle. This can be the link capacitor described in reference to the preceding figures, with the exception that the complementary coupling element 125 and the busbars 110, 115 are different.

According to one exemplary embodiment, the complementary coupling element 125 is on the other side wall 720 of the housing 105, and forms a dovetail connection. The complementary coupling element 125 is designed to secure the link capacitor in both directions along the z-axis.

The ends of the first busbar 110 extend from the top 155 of the housing 105, and the ends of the second busbar 115 extend from the opposing side walls 140 and 145. The other coupling element 150 is on the bottom 160 of the housing 105 in this exemplary embodiment in the form of a pin that secures the link capacitor along the x-axis and y-axis. The other coupling element 150 in FIG. 10 is therefore used to position the link capacitor and block any movement thereof along the x- and y-axes.

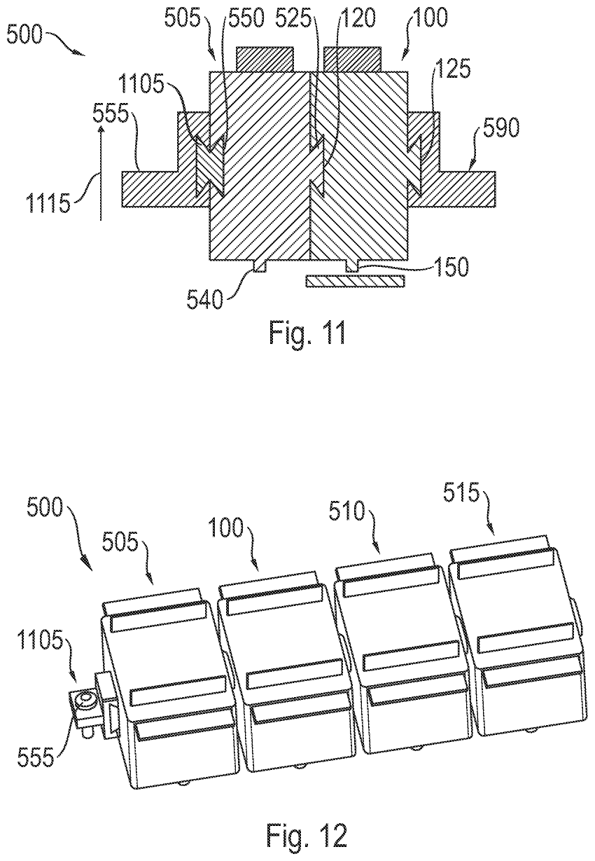

FIG. 11 shows an illustration of an exemplary embodiment of a capacitor assembly 500. This capacitor assembly 500 is similar to the capacitor assembly described in reference to any of the preceding figures. The capacitor assembly 500 contains the link capacitor 100 and the first adjacent link capacitor 505.

The coupling element 120 is designed to couple the link capacitor 100 to the first adjacent link capacitor 505 with the first complementary coupling element 525. According to one exemplary embodiment, the complementary coupling element 125 can be attached to a support element with another fastener 590.

The first adjacent link capacitor 505 can be attached to a support element with a clamp element 1105, which can also be referred to as a clamp component, and a fastener 555. The clamp element 1105 is coupled to the other first coupling element 550 on the first adjacent link capacitor 505 for this. The first adjacent link capacitor 505 has the first coupling element 540 on the bottom 160, by way of example. The first coupling element 540 and the other coupling element 150 are designed to position the first adjacent link capacitor 505 and the link capacitor 100 in a groove in a support element. The coupling element 150 and first coupling element 540 are thus used to position the housings, and not to couple the link capacitors 100, 505. The arrow 1115 indicates the z-axis.

FIG. 12 shows an illustration of a capacitor assembly 500 according to an exemplary embodiment. The capacitor assembly 500 is similar to the capacitor assembly described in reference to any of the preceding figures. The capacitor assembly 500 contains the link capacitor 100 and the first adjacent link capacitor 505. In this exemplary embodiment, the capacitor assembly 500 contains the second adjacent link capacitor 510 and the third adjacent link capacitor 515. The link capacitor 100 is between the first adjacent link capacitor 505 and the second adjacent link capacitor 510. The second adjacent link capacitor 510 is between the link capacitor 100 and the third adjacent link capacitor 515.

The first adjacent link capacitor 505 can be coupled to a support element by the clamp element 1105 and the fastener 555.

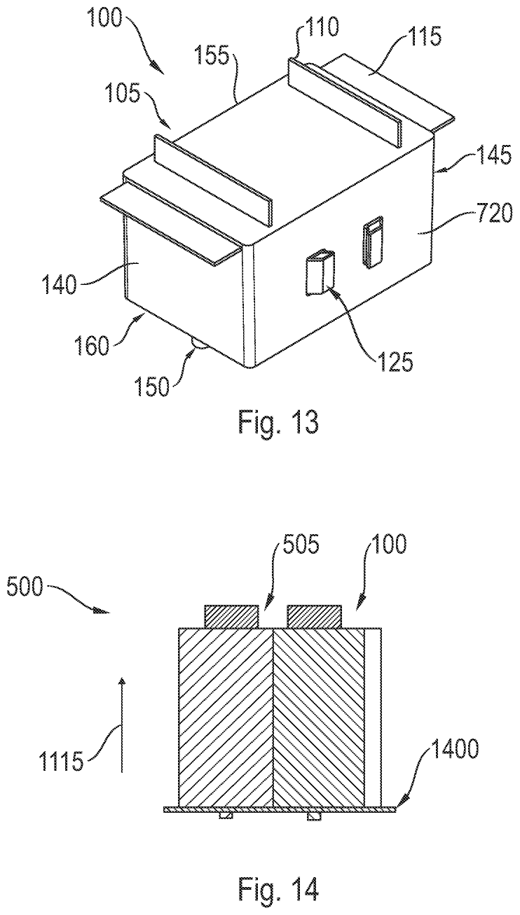

FIG. 13 shows an illustration of an exemplary embodiment of a link capacitor 100 for an inverter in a motor vehicle. This link capacitor 100 is similar to the link capacitor shown in FIG. 10, with the exception that the complementary coupling element 125 is rotated 90° on the second side wall 720.

FIG. 14 shows an illustration of an exemplary embodiment of a capacitor assembly 500. This capacitor assembly 500 corresponds to the capacitor assembly shown in FIG. 13. The capacitor assembly 500 contains the link capacitor 100 and the first adjacent link capacitor 505.

The link capacitor 100 is coupled in a form-fitting manner to the first adjacent link capacitor 505. In this exemplary embodiment, there is a securing material 1400 on the bottom 160 of the link capacitor 100 and the bottom of the first adjacent link capacitor 505, with which the link capacitor 100 can be secured to the first adjacent link capacitor 505. The securing material 1400 can also be referred to as adhesive. The arrow 1115 indicates the z-axis.

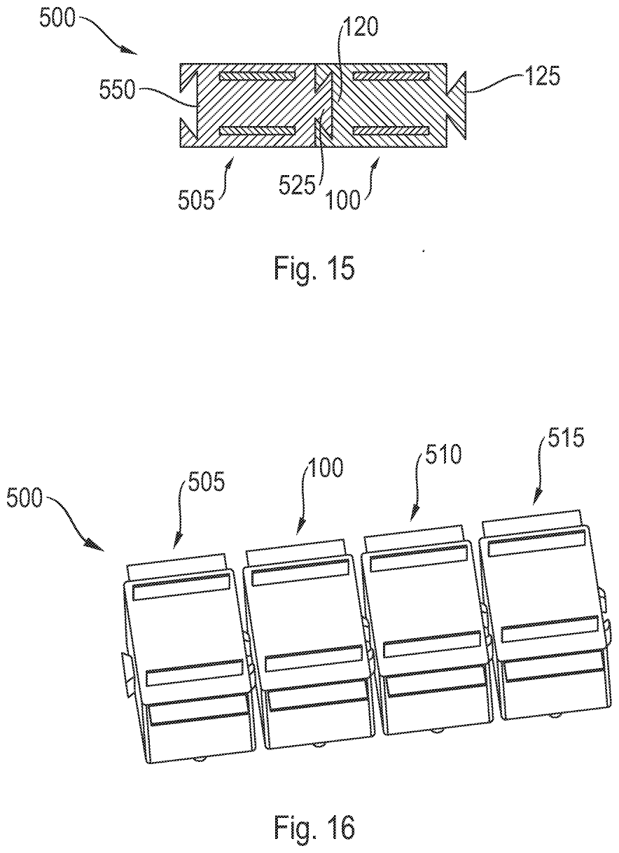

FIG. 15 shows a top view of an exemplary embodiment of a capacitor assembly 500. This shows the capacitor assembly from FIG. 14 from another direction. The capacitor assembly 500 represents an example of a capacitor structure for an inverter, for example.

The coupling element 120 is designed to couple the link capacitor 100 to the first adjacent link capacitor 505 with the first complementary coupling element 525.

FIG. 16 shows an illustration of a capacitor assembly 500 according to an exemplary embodiment. The capacitor assembly 500 corresponds to the capacitor assembly described in reference to the preceding FIGS. 13 to 15. The capacitor assembly 500 contains the link capacitor 100 and the first adjacent link capacitor 505. According to this exemplary embodiment, the capacitor assembly 500 contains the second adjacent link capacitor 510 and the third adjacent link capacitor 515. The link capacitor 100 is between the first adjacent link capacitor 505 and the second adjacent link capacitor 510. The second adjacent link capacitor 510 is between the link capacitor 100 and the third adjacent link capacitor 515.

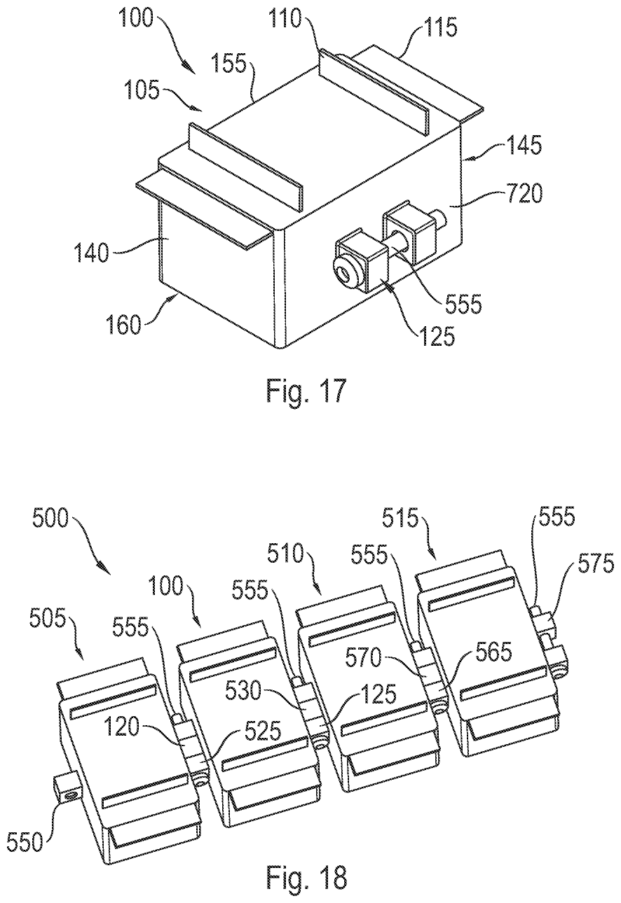

FIG. 17 shows an illustration of an exemplary embodiment of a link capacitor 100 for an inverter in a motor vehicle. The link capacitor 100 is similar to the link capacitor in FIG. 10 and/or FIG. 13, with the exception that the complementary coupling element 125 is formed by at least one projection on the side wall 720 with a hole passing through it. The complementary coupling element 125 can also be used with a threaded fastener. The complementary coupling element 125 has two projections for this, which are spaced apart, parallel to one another. A coupling element can be inserted into the space between the two projections of the complementary coupling element 125. If the complementary coupling element also forms a projection with a hole passing through it, a fastener 555 in the form of a bolt or screw can be threaded into the holes passing through the coupling element and the complementary coupling element.

By way of example, the projections of the complementary coupling element 125 and the projection of the corresponding coupling element can be rectangular. The width of the gap between the projections of the complementary coupling element 125 is the same size as the width of the projection of the coupling element in one exemplary embodiment, such that a relative movement of two link capacitors coupled via the complementary coupling element 125 and the coupling element is blocked in a longitudinal direction of the fastener 555. In turn, the fastener 555 blocks a relative movement of the link capacitors to one another in the direction transverse to the longitudinal direction of the fastener 555.

FIG. 18 shows an illustration of a capacitor assembly 500 according to an exemplary embodiment. The capacitor assembly 500 is similar to the capacitor assembly in FIG. 16. The capacitor assembly 500 contains the link capacitor 100 and the first adjacent link capacitor 505. According to this exemplary embodiment, the capacitor assembly also contains the second adjacent link capacitor 510 and the third adjacent link capacitor 515. The link capacitor 100 is between the first adjacent link capacitor 505 and the second adjacent link capacitor 510. The second adjacent link capacitor 510 is between the link capacitor 100 and the third adjacent link capacitor 515.

The complementary coupling element 125 on the link capacitor 100 is coupled to the second coupling element 530 on the second adjacent link capacitor 510. The coupling element 120 on the link capacitor 100 is coupled to the first complementary coupling element 525 on the first adjacent link capacitor 505. The coupling element 120 forms a projection with a hole passing through it, such that a form-fitting connection to the first complementary coupling element 525 can be obtained. The fastener 555 is slid into the holes in the first complementary coupling element 525 and the coupling element 120 in order to couple the link capacitor 100 to the first adjacent link capacitor 505 in a form-fitting and/or force-fitting manner.

Adjacent link capacitors 100, 505, 510, 515 can be coupled to one another in this manner.

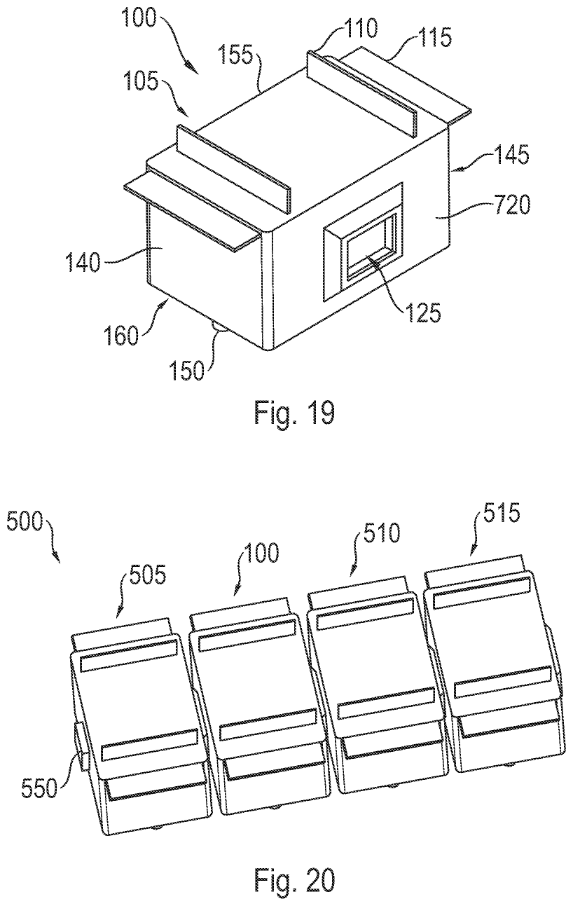

FIG. 19 shows an illustration of an exemplary embodiment of a link capacitor 100 for an inverter in a motor vehicle. The link capacitor 100 is similar to the link capacitor in FIGS. 10, 13, and/or 17, with the exception that the complementary coupling element 125 forms a frame with which a form-fitting connection can be obtained with a corresponding coupling element.

FIG. 20 shows an illustration of a capacitor assembly 500 according to an exemplary embodiment. The capacitor assembly 500 is similar to the capacitor assembly shown in FIG. 16 and/or FIG. 18. The capacitor assembly 500 contains the link capacitor 100 and the first adjacent link capacitor 505. In this exemplary embodiment, the capacitor assembly 500 contains the second adjacent link capacitor 510 and the third adjacent link capacitor 515. The link capacitor 100 is between the first adjacent link capacitor 510 and the second adjacent link capacitor 515. The second adjacent link capacitor 510 is between the link capacitor 100 and the third adjacent link capacitor 515.

The link capacitors 100, 505, 510, 515 are coupled in a form-fitting manner to one another. By way of example, the link capacitors 100, 505, 510, 515 correspond to the link capacitor described in reference to FIG. 19. The link capacitors 100, 505, 510, 515 each have a coupling element 550 that corresponds to the complementary coupling element shown in FIG. 19. The corresponding coupling element 550 is formed by a plate-shaped projection on a side wall that fits into the frame of the complementary coupling element. The shape of the coupling element 550 therefore fits into the space encompassed by the frame forming the complementary coupling element.

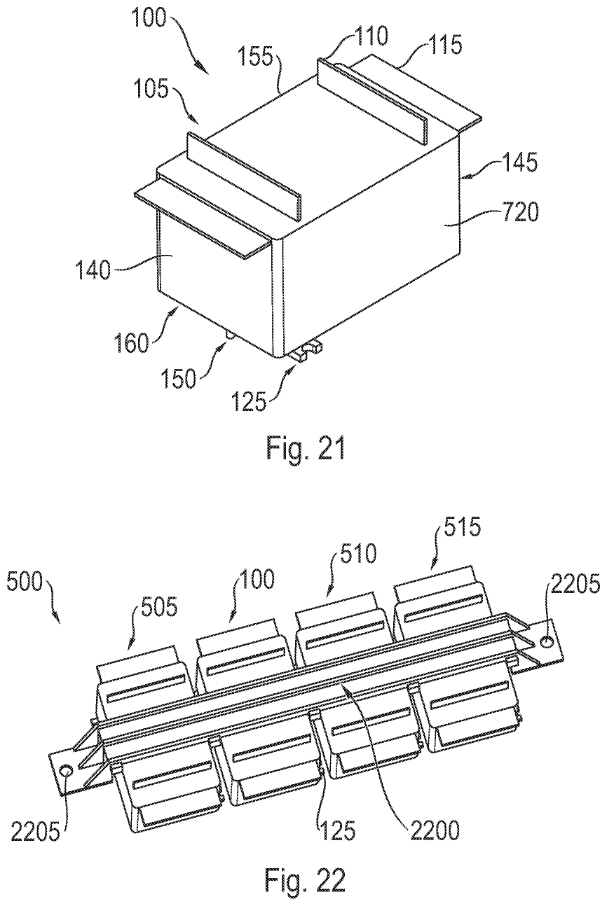

FIG. 21 shows an illustration of an exemplary embodiment of a link capacitor 100 for an inverter in a motor vehicle. The link capacitor 100 is similar to the link capacitor shown in FIGS. 10, 13, 17 and/or 19, with the exception that the complementary coupling element 125 is on the bottom 160 of the housing 105, and protrudes therefrom. The complementary coupling element 125 can also be regarded as a positioning element. In the variation shown in FIG. 21, the coupling element forms a stud or pin on the housing, for example.

FIG. 22 shows an illustration of a capacitor assembly 500 according to an exemplary embodiment. The capacitor assembly 500 is similar to the capacitor assembly shown in FIG. 16, FIG. 18, and/or FIG. 20. The capacitor assembly 500 contains the link capacitor 100 and the first adjacent link capacitor 505. In this exemplary embodiment, the capacitor assembly 500 also contains the second adjacent link capacitor 510 and the third adjacent link capacitor 515. The link capacitor 100 is between the first adjacent link capacitor 510 and the second adjacent link capacitor 515. The second adjacent link capacitor 510 is between the link capacitor 100 and the third adjacent link capacitor 515. In this exemplary embodiment, the capacitor assembly 500 has a retaining element 2200 with which the link capacitors 100, 505, 510, 515 are attached to a support element. This retaining element 2200 has a hole 2205 on each end for a fastener. The retaining element 2200 can also be referred to as a supplementary retaining element with elastomer elements that compensate for tolerances.

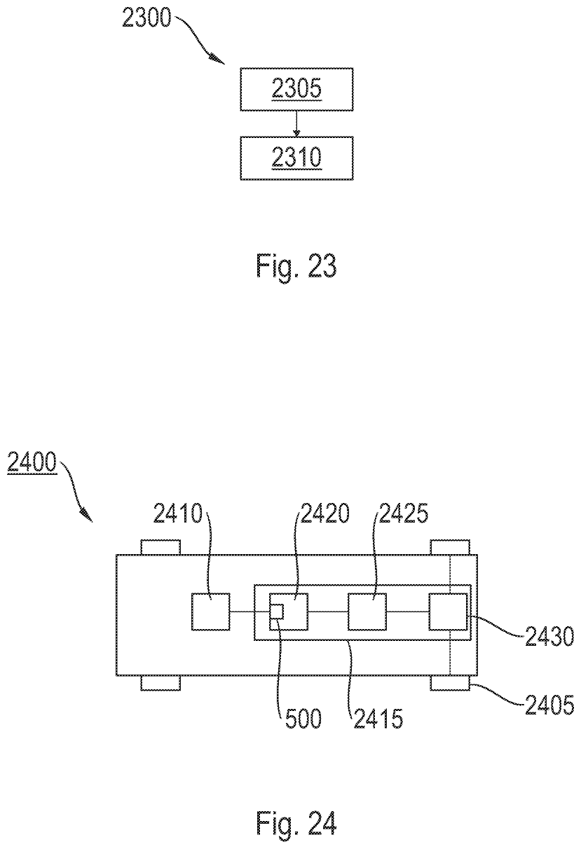

FIG. 23 shows a flow chart for an exemplary embodiment of a method 2300 for producing a link capacitor. The link capacitor corresponds, or is similar, to the link capacitor described in reference to any of the drawings. The method 2300 contains a providing step 2305 and a coating step 2310. In the providing step 2305, a winding, first busbar and second busbar are provided. In the coating step 2310, the winding is coated with a thermosetting plastic, which forms a housing with at least one coupling element for coupling the link capacitor to an adjacent link capacitor and/or a support element. A complementary coupling element can also be formed on the housing in the coating step 2310.

FIG. 24 shows a schematic illustration of an exemplary embodiment of a motor vehicle 2400. The motor vehicle 2400 has at least one driven wheel 2405, in this case four driven wheels, merely by way of example, an electricity storage unit 2410, e.g. a battery, and an electric axle drive 2415 in the illustration. The electric axle drive 2415 comprises a power converter 2420, an electric machine 2425, and a transmission 2430.

The electricity for operating the electric machine 2425 is supplied by an energy supply unit, the electricity storage unit 2410 in this case. The electricity storage unit 2410 supplies a direct current, which is converted to an alternating current by the power converter 2420 for the electric axle drive 2415, a three-phase alternating current in this case, and supplied to the electric machine 2425. A shaft powered by the electric machine 2425 is coupled directly, or via the transmission 2430, to at least one wheel 2405 on the motor vehicle 2400. The motor vehicle 2400 can be powered by the electric machine 2425 in this manner. In one exemplary embodiment, the electric axle drive 2415 has as housing containing the power converter 2420, electric machine 22425 and transmission 2430.

According to one exemplary embodiment, the power converter 2420 comprises at least one capacitor assembly 500, such as that described in reference to any of the preceding figures. By way of example, the capacitor assembly 500 is located in link in the power converter 2420. Instead of, or in addition to, the power converter 2420, the capacitor 500 can also be used for an HVDC converter, a charger, e.g. for charging an inverter, or for power electronics in the motor vehicle 2400.

### LIST OF REFERENCE SYMBOLS

100 link capacitor
105 housing
110 first busbar
115 second busbar
120 coupling element
125 complementary coupling element
130 contact
135 separating web
140 side wall
145 opposite side wall
150 other coupling element
155 top
160 bottom
200 support point
205 other complementary coupling element
300 winding
500 capacitor assembly
505 first adjacent link capacitor
510 second adjacent link capacitor
515 third adjacent link capacitor
520 support element
525 first complementary coupling element
530 second coupling element
535 second complementary coupling element
540 first coupling element
545 other first complementary coupling element
550 other first coupling element
555 fastener
560 other second coupling element
565 other second complementary coupling element
570 third coupling element
575 third complementary coupling element
580 other third coupling element
585 other third complementary coupling element
590 other fastener
600 groove
700 space
705 supplementary complementary coupling element
710 supplementary coupling element
715 other supplementary complementary coupling element
720 other side wall
725 recess
800 other supplementary coupling element
1105 clamping element
1115 arrow
1400 securing material
2200 retaining element
2205 hole
2300 method for producing a link capacitor
2305 providing step
2310 coating step
2400 motor vehicle
2405 wheel
2410 electricity storage unit
2415 electric axle drive
2420 power converter
2425 electric machine
2430 transmission

1. A link capacitor for a motor vehicle, comprising:
a housing, wherein the housing accommodates a winding for the link capacitor;
a first busbar and second busbar for electrical contact to the link capacitor, wherein the first busbar and second busbar are connected to the winding; and
at least one coupling element on the housing that is designed to couple the link capacitor to an adjacent link capacitor and/or a support element.

2. The link capacitor according to claim 1, comprising:
a complementary coupling element, wherein the coupling element is designed to couple the link capacitor to a first adjacent link capacitor with a first complementary coupling element, and wherein the complementary coupling element is designed to couple the link capacitor to a second adjacent link capacitor with a second coupling element.

3. The link capacitor according to claim 2, wherein the coupling element and the complementary coupling element are both on a top or both on a bottom of the housing.

4. The link capacitor according to claim 2, wherein the coupling element is on a first side wall of the housing and wherein the complementary coupling element in on a second side wall lying opposite the first side wall.

5. The link capacitor according to claim 1, wherein the coupling element is designed to couple the link capacitor to the adjacent link capacitor and/or the support element in a form-fitting or force-fitting manner.

6. The link capacitor according to claim 1, wherein the housing and the coupling element form an elastomer coating on the winding.

7. A capacitor assembly comprising:
the link capacitor according to claim 1; and
an adjacent link capacitor,
wherein the coupling element on the link capacitor is coupled to a first complementary coupling element on the adjacent link capacitor.

8. The capacitor assembly according to claim 7, comprising:
a support element, wherein the link capacitor and/or the adjacent link capacitor are on the support element.

9. The capacitor assembly according to claim 8, comprising:
a retaining element that is designed to retain the link capacitor and/or the adjacent link capacitor on the support element.

10. The capacitor assembly according to claim 7, wherein the link capacitor is configured to be secured to the adjacent link capacitor and/or the support element by a securing material.

11. The capacitor assembly according to claim 7, comprising:
a printed circuit board that is electrically connected to the link capacitor and/or the adjacent link capacitor.

12. A power converter, HVDC converter, charger for charging an inverter, or power electronics comprising the capacitor assembly according to claim 7.

13. An electric axle drive for a motor vehicle, comprising:
at least one electric machine;
a transmission; and
the power converter, HVDC converter, charger for charging an inverter, or power electronics according to claim 12.

14. A motor vehicle, comprising:
the power converter, HVDC converter, charger for charging an inverter, or power electronics according to claim 12.

15. A motor vehicle, comprising:
the electric axle drive according to claim 13.

16. A method for producing a link capacitor, comprising:
providing a winding, a first busbar, and a second busbar; and
coating the winding with a thermosetting plastic to obtain a housing that has a coupling element for coupling the link capacitor to an adjacent link capacitor and/or a support element.
